(19) United States
(12) Patent Application Publication
(10) Pub. No.: US 2010/0262711 A1
(43) Pub. Date: Oct. 14, 2010

(54) SYSTEMS, METHODS, AND APPARATUSES FOR MEDIA FILE STREAMING

(75) Inventor: Imed Bouazizi, Tampere (FI)

Correspondence Address: Nokia, Inc., 6021 Connection Drive, MS 2-5-520, Irving, TX, 75039, US

(73) Assignee: NOKIA CORPORATION, Espoo (FI)

(21) Appl. No.: 12/756,891

(22) Filed: Apr. 8, 2010

Related U.S. Application Data
(60) Provisional application No. 61/168,195, filed on Apr. 9, 2009.

(51) Int. Cl. G06F 15/16

(52) U.S. Cl. 709/231

(57) ABSTRACT

A method, apparatus, and system are provided for media file streaming. A method may include receiving a transfer protocol request for a media file indicating that the media file is to be streamed to a client device requesting the media file. The method may further include transmitting at least a portion of metadata describing at least a portion of the media file content. The method may additionally include extracting one or more other portions of metadata corresponding to one or more media data samples in the media file. The method may also include progressively transmitting the extracted one or more other portions of metadata with the corresponding one or more media data samples from the media file. Corresponding apparatuses and systems are also provided.

### TECHNOLOGICAL FIELD

Embodiments of the present invention relate generally to communications technology and, more particularly, relate to systems, methods and apparatuses for media file streaming.

### BACKGROUND

The modern communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer. Current and future networking technologies as well as evolved computing devices making use of networking technologies continue to facilitate ease of information transfer and convenience to users. In this regard, the expansion of networks and evolution of networked computing devices has provided sufficient processing power, storage space, and network bandwidth to enable the transfer and playback of increasingly complex digital media files. Accordingly, Internet television and video sharing are gaining widespread popularity.

### BRIEF SUMMARY OF SOME EXAMPLES OF THE INVENTION

A method, apparatus, and computer program product are therefore provided for facilitating streaming of media files using a transport protocol, such as HTTP. In this regard, a method, apparatus, and computer program product are provided that may provide several advantages to computing devices, computing device users, and network operators. In one exemplary embodiment of the invention, media content may be streamed using TCP over HTTP without limit to a proprietary media format. In this regard streaming of media content may be facilitated for media content formatted in accordance with any media file format based upon the International Organization for Standardization (ISO) base media file format. In accordance with embodiments of the invention, a protocol for streaming of media content is provided that is interoperable with various network types, including, for example, local area networks, the Internet, wireless networks, wireline networks, cellular networks, and the like.

In embodiments of the invention, network bandwidth consumption and processing requirements of computing devices receiving and playing back streaming media are reduced. In this regard, more efficient use of network bandwidth may be made by reducing the amount of metadata transmitted for a media file by selectively extracting and progressively delivering only that data required by the receiver for playback of the streaming media. A device playing back the streaming media may benefit from embodiments of the invention by not having to receive and process as much data.

Additionally, mobile devices playing back streaming media may also enjoy benefits in accordance with embodiments of the invention. By way of example, streaming of Third Generation Partnership Project (3GPP) media files (3GP media files), such as by using HTTP, may be facilitated. Accordingly, 3GPP Packet Switched Streaming Service (PSS) may be benefited through the provision of support for such streaming, thus strengthening PSS as a means for mobile unicast streaming. Further, streaming media to mobile devices may be improved in accordance with embodiments of the invention by facilitating the use of established PSS media codecs and formats combined with mobile specific functionality (e.g., profile indication, Quality of Experience reporting, and/or the like).

In a first exemplary embodiment, a method is provided, which includes receiving a transfer protocol request for a media file indicating that the media file is to be streamed to a client device requesting the media file. The method of this embodiment further includes transmitting at least a portion of metadata describing at least a portion of the media file content. The method of this embodiment also includes extracting one or more other portions of metadata corresponding to one or more media data samples in the media file. The method of this embodiment additionally includes progressively transmitting the extracted one or more other portions of metadata with the corresponding one or more media data samples from the media file.

In another exemplary embodiment, a computer program product is provided. The computer program product includes at least one computer-readable storage medium having computer-readable program instructions stored therein. The computer-readable program instructions may include a plurality of program instructions. Although in this summary, the program instructions are ordered, it will be appreciated that this summary is provided merely for purposes of example and the ordering is merely to facilitate summarizing the computer program product. The example ordering in no way limits the implementation of the associated computer program instructions. The first program instruction of this embodiment is for causing a transfer protocol request for a media file to be received, wherein the request indicates that the media file is to be streamed to a client device requesting the media file. The second program instruction of this embodiment is for causing at least a portion of metadata describing at least a portion of the media file content to be transmitted. The third program instruction of this embodiment is for extracting one or more other portions of metadata corresponding to one or more media data samples in the media file. The fourth program instruction of this embodiment is for causing the extracted one or more other portions of metadata with the corresponding one or more media data samples from the media file to be progressively transmitted.

In another exemplary embodiment, an apparatus is provided. The apparatus of this embodiment includes a processor and a memory storing instructions that when executed by the processor cause the apparatus to receive a transfer protocol request for a media file indicating that the media file is to be streamed to a client device requesting the media file. The transfer protocol request may, for example, comprise an HTTP GET request comprising a header field including a token indicating that the media file is to be streamed. The instructions of this embodiment when executed by the processor further cause the apparatus to transmit at least a portion of metadata describing at least a portion of the media file content. The instructions of this embodiment when executed by the processor additionally cause the apparatus to extract one or more other portions of metadata corresponding to one or more media data samples in the media file. The instructions of this embodiment when executed by the processor also cause the apparatus to progressively transmit the extracted one or more other portions of metadata with the corresponding one or more media data samples from the media file.

In another exemplary embodiment, an apparatus is provided, which includes means for receiving a transfer protocol request for a media file indicating that the media file is to be streamed to a client device requesting the media file. The transfer protocol request may, for example, comprise an HTTP GET request comprising a header field including a token indicating that the media file is to be streamed. The apparatus of this embodiment further includes means for transmitting at least a portion of metadata describing at least a portion of the media file content. The apparatus of this embodiment also includes means for extracting one or more other portions of metadata corresponding to one or more media data samples in the media file. The apparatus of this embodiment additionally includes means for progressively transmitting the extracted one or more other portions of metadata with the corresponding one or more media data samples from the media file.

In another exemplary embodiment, a method is provided, which includes sending a transfer protocol request for a media file to a media content source. The transfer protocol request comprises an indication that the media file is to be streamed. The transfer protocol request may, for example, comprise an HTTP GET request comprising a header field including a token indicating that the media file is to be streamed. The method of this embodiment further includes receiving at least a portion of metadata describing at least a portion of the media file content. The method of this embodiment additionally includes progressively receiving one or more other portions of metadata with one or more media data samples from the media file that correspond to the one or more other portions of metadata.

In another exemplary embodiment, a computer program product is provided. The computer program product includes at least one computer-readable storage medium having computer-readable program instructions stored therein. The computer-readable program instructions may include a plurality of program instructions. Although in this summary, the program instructions are ordered, it will be appreciated that this summary is provided merely for purposes of example and the ordering is merely to facilitate summarizing the computer program product. The example ordering in no way limits the implementation of the associated computer program instructions. The first program instruction of this embodiment is for causing a transfer protocol request for a media file to be sent to a media content source. The transfer protocol request comprises an indication that the media file is to be streamed. The transfer protocol request may, for example, comprise an HTTP GET request comprising a header field including a token indicating that the media file is to be streamed. The second program instruction of this embodiment is for causing at least a portion of metadata describing at least a portion of the media file content to be received. The third program instruction of this embodiment is for causing one or more other portions of metadata with one or more media data samples from the media file that correspond to the one or more other portions of metadata to be progressively received.

In another exemplary embodiment, an apparatus is provided. The apparatus of this embodiment includes a processor and a memory storing instructions that when executed by the processor cause the apparatus to send a transfer protocol request for a media file to a media content source. The transfer protocol request comprises an indication that the media file is to be streamed. The transfer protocol request may, for example, comprise an HTTP GET request comprising a header field including a token indicating that the media file is to be streamed. The instructions of this embodiment when executed by the processor further cause the apparatus to receive at least a portion of metadata describing at least a portion of the media file content. The instructions of this embodiment when executed by the processor additionally cause the apparatus to progressively receive one or more other portions of metadata with one or more media data samples from the media file that correspond to the one or more other portions of metadata.

In another exemplary embodiment, an apparatus is provided, which includes means for sending a transfer protocol request for a media file to a media content source. The transfer protocol request comprises an indication that the media file is to be streamed. The transfer protocol request may, for example, comprise an HTTP GET request comprising a header field including a token indicating that the media file is to be streamed. The apparatus of this embodiment further includes means for receiving at least a portion of metadata describing at least a portion of the media file content. The apparatus of this embodiment additionally includes means for progressively receiving one or more other portions of metadata with one or more media data samples from the media file that correspond to the one or more other portions of metadata.

The apparatus of this embodiment may additionally include means for selecting a subset of media tracks of the media file based at least in part upon the received description of at least a portion of the media file and means for sending the selection to the media content source. The means for receiving media data may comprise means for receiving media data comprising one or more of the selected subset of media tracks.

The above summary is provided merely for purposes of summarizing some example embodiments of the invention so as to provide a basic understanding of some aspects of the invention. Accordingly, it will be appreciated that the above described example embodiments are merely examples and should not be construed to narrow the scope or spirit of the invention in any way. It will be appreciated that the scope of the invention encompasses many potential embodiments, some of which will be further described below, in addition to those here summarized.

### BRIEF DESCRIPTION OF THE DRAWING(S)

Having thus described embodiments of the invention in general terms, reference will now be made to the accompanying drawings, which are not necessarily drawn to scale, and wherein:

FIG. 1 illustrates a system for facilitating streaming of media files using a transfer protocol according to an exemplary embodiment of the present invention;

FIG. 2 is a schematic block diagram of a mobile terminal according to an exemplary embodiment of the present invention;

FIG. 3 illustrates an exemplary hierarchy of a plurality of levels of metadata for an ISO base file format compliant media file according to an exemplary embodiment of the present invention;

FIG. 4 illustrates a framing of a sample divided into a series of fragments according to an exemplary embodiment of the invention;

FIG. 5 illustrates a framing of a sample according to an exemplary embodiment of the invention; and

FIGS. 6-8 illustrate flowcharts according to exemplary methods for facilitating streaming of media files using a transfer protocol according to exemplary embodiments of the invention.

### DETAILED DESCRIPTION

Some embodiments of the present invention will now be described more fully hereinafter with reference to the accompanying drawings, in which some, but not all embodiments of the invention are shown. Indeed, it should be appreciated that many other potential embodiments of the invention, in addition to those illustrated and described herein, may be embodied in many different forms. Embodiments of the present invention should not be construed as limited to the embodiments set forth herein; rather, the embodiments set forth herein are provided so that this disclosure will satisfy applicable legal requirements. Like reference numerals refer to like elements throughout.

As used herein, “exemplary” merely means an example and as such represents one example embodiment for the invention and should not be construed to narrow the scope or spirit of embodiments of the invention in any way. Further, it should be appreciated that the hypertext transfer protocol (HTTP) is used as an example of an application layer transfer protocol. Example embodiments of the invention comprise streaming of media files using other application layer transfer protocols.

Some multimedia content providers use real-time transport protocol (RTP) over user datagram protocol (UDP) for media streaming. In this regard, UDP provides basic transport functionality such as application addressing and corruption detection. RTP complements UDP with media transport relevant functionality, such as loss detection, packet re-ordering, synchronization, statistical data collection, and session participant identification. However, RTP over UDP (RTP/UDP) does not provide built-in congestion control and/or error correction functionality. RTP/UDP may gather sufficient information for implementing congestion control and/or error correction functionality on a need basis at an application level. In this regard, with the rising popularity of mobile and internet video, it is desired to maintain good network behavior through appropriate rate control mechanisms. In RTP/UDP-based streaming applications is, the sender and/or receiver of the streaming media, if not appropriately configured, may fail to traverse network address translation (NAT) device(s) and/or a firewall(s) positioned in the streaming path between the sender and receiver.

Hypertext transfer protocol (HTTP) media delivery, for example, may provide an alternative to real-time streaming based on real time streaming protocol (RTSP) and/or RTP, in packet switched streaming service (PSS). HTTP media delivery solutions enable easy and effortless streaming services to 3rd generation partnership project (3GPP) user equipments by overcoming NAT and firewall traversal issues. PSS already defines a solution for the delivery of media files using HTTP, e.g., progressive download, in a way that is similar to streaming. Progressive download is both supported by PSS encoders/decoders (codecs) and protocols as well as by 3GP file format.

A 3GP file compliant to the progressive download profile usually fulfills the requirement for the interleaving of media tracks at an interleaving time intervals. The media data is partitioned into chunks, for example corresponding to playback duration no longer than 1 second or into chunks each of which comprises a single sample. In the PSS progressive download solution, data delivery may be not optimized for short-delay playback. For example, the use of HTTP over transmission control protocol (TCP) for real-time media streaming may pose drawbacks due to the use of aggressive congestion and flow control algorithms, the connection-oriented nature, the requirement of strict in-order delivery of packets containing media data, and the retransmission-based error control protocols, e.g., slow-start restart protocol. HTTP based delivery may result in significant fluctuations of the throughput and may require a high level of initial buffering to cope with the variable throughput. A significant amount of network resources may be consumed for the transmission of un-necessary metadata. For example, in a media file compliant with international organization for standardization (ISO) base media file format, the metadata is usually located at the start of the file. When transmitting the media file, the metadata is usually transmitted before the transmission of any media data. Usability of progressive download for providing video on demand functionality may not be desired due to a lack of control over a progressive download session.

According to an example embodiment of the present invention, real-time HTTP streaming is achieved by progressively transmitting portions of metadata with corresponding chunks of media data. For example, only portions of the metadata that are useful for the client device in decoding and/or playing back the chunks of media data are transmitted.

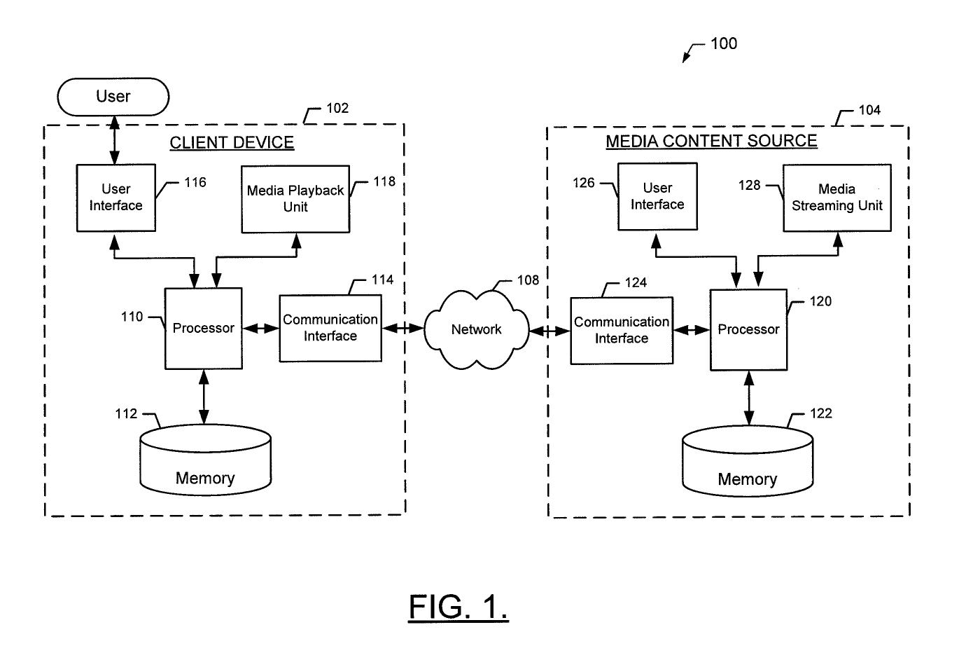

FIG. 1 illustrates a block diagram of a system 100 for streaming media files using an application layer transfer protocol, such as hypertext transfer protocol (HTTP), according to an example embodiment of the present invention. In an example embodiment, the system 100 comprises a client device 102 and a media content source 104. The client device 102 and the media content source 104 are configured to communicate over a network 108. The network 108, for example, comprises one or more wireline networks, one or more wireless networks, or some combination thereof. The network 108 comprises a public land mobile network (PLMN) operated by a network operator. In this regard, the network 108, for example, comprises an operator network providing cellular network access, such as in accordance with 3GPP standards. The network 108 may additionally or alternatively comprise the internet.

The client device 102 comprises any device configured to access media files from a media content source 104 over the network 108. For example, the client device 102 comprises a server, a desktop computer, a laptop computer, a mobile terminal, a mobile computer, a mobile phone, a mobile communication device, a game device, a digital camera/camcorder, an audio/video player, a television device, a radio receiver, a digital video recorder, a positioning device, any combination thereof, and/or the like.

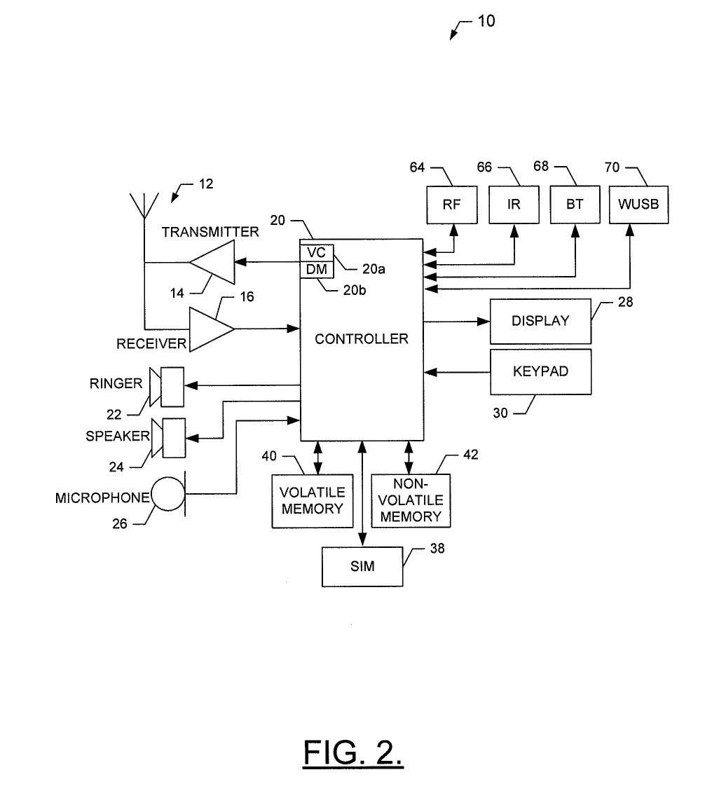

In an example embodiment, the client device 102 is embodied as a mobile terminal, such as that illustrated in FIG. 2. In this regard, FIG. 2 illustrates a block diagram of a mobile terminal 10 representative of one embodiment of a client device 102 in accordance with embodiments of the present invention. It should be understood, however, that the mobile terminal 10 illustrated and hereinafter described is merely illustrative of one type of client device 102 that may implement and/or benefit from embodiments of the present invention and, therefore, should not be taken to limit the scope of the present invention. While several embodiments of the electronic device are illustrated and will be hereinafter described for purposes of example, other types of electronic devices, such as mobile telephones, mobile computers, portable digital assistants (PDAs), pagers, laptop computers, desktop computers, gaming devices, televisions, and other types of electronic systems, may employ embodiments of the present invention.

As shown, the mobile terminal 10 may include an antenna 12 (or multiple antennas 12) in communication with a transmitter 14 and a receiver 16. The mobile terminal may also include a controller 20 or other processor(s) that provides signals to and receives signals from the transmitter and receiver, respectively. These signals may include signaling information in accordance with an air interface standard of an applicable cellular system, and/or any number of different wireline or wireless networking techniques, comprising but not limited to Wireless-Fidelity (Wi-Fi), wireless local access network (WLAN) techniques such as Institute of Electrical and Electronics Engineers (IEEE) 802.11, and/or the like. In addition, these signals may include speech data, user generated data, user requested data, and/or the like. In this regard, the mobile terminal may be capable of operating with one or more air interface standards, communication protocols, modulation types, access types, and/or the like. More particularly, the mobile terminal may be capable of operating in accordance with various first generation (1G), second generation (2G), 2.5G, third-generation (3G) communication protocols, fourth-generation (4G) communication protocols, and/or the like. For example, the mobile terminal may be capable of operating in accordance with 2G wireless communication protocols IS-136 (Time Division Multiple Access (TDMA)), Global System for Mobile communications (GSM), IS-95 (Code Division Multiple Access (CDMA)), and/or the like. Also, for example, the mobile terminal may be capable of operating in accordance with 2.5G wireless communication protocols General Packet Radio Service (GPRS), Enhanced Data GSM Environment (EDGE), and/or the like. Further, for example, the mobile terminal may be capable of operating in accordance with 3G wireless communication protocols such as Universal Mobile Telecommunications System (UMTS), Code Division Multiple Access 2000 (CDMA2000), Wideband Code Division Multiple Access (WCDMA), Time Division-Synchronous Code Division Multiple Access (TD-SCDMA), and/or the like. The mobile terminal may be additionally capable of operating in accordance with 3.9G wireless communication protocols such as Long Term Evolution (LTE) or Evolved Universal Terrestrial Radio Access Network (E-UTRAN) and/or the like. Additionally, for example, the mobile terminal may be capable of operating in accordance with fourth-generation (4G) wireless communication protocols and/or the like as well as similar wireless communication protocols that may be developed in the future.

Some Narrow-band Advanced Mobile Phone System (NAMPS), as well as Total Access Communication System (TACS), mobile terminals may also benefit from embodiments of this invention, as should dual or higher mode phones (e.g., digital/analog or TDMA/CDMA/analog phones). Additionally, the mobile terminal 10 may be capable of operating according to Wireless Fidelity (Wi-Fi) or Worldwide Interoperability for Microwave Access (WiMAX) protocols.

It is understood that the controller 20 may comprise circuitry for implementing audio/video and logic functions of the mobile terminal 10. For example, the controller 20 may comprise a digital signal processor device, a microprocessor device, an analog-to-digital converter, a digital-to-analog converter, and/or the like. Control and signal processing functions of the mobile terminal may be allocated between these devices according to their respective capabilities. The controller may additionally comprise an internal voice coder (VC) 20a, an internal data modem (DM) 20b, and/or the like. Further, the controller may comprise functionality to operate one or more software programs, which may be stored in memory. For example, the controller 20 may be capable of operating a connectivity program, such as a web browser. The connectivity program may allow the mobile terminal 10 to transmit and receive web content, such as location-based content, according to a protocol, such as Wireless Application Protocol (WAP), hypertext transfer protocol (HTTP), and/or the like. The mobile terminal 10 may be capable of using a Transmission Control Protocol/Internet Protocol (TCP/IP) to transmit and receive web content across the internet or other networks.

The mobile terminal 10 may also comprise a user interface including, for example, an earphone or speaker 24, a ringer 22, a microphone 26, a display 28, a user input interface, and/or the like, which may be operationally coupled to the controller 20. Although not shown, the mobile terminal may comprise a battery for powering various circuits related to the mobile terminal, for example, a circuit to provide mechanical vibration as a detectable output. The user input interface may comprise devices allowing the mobile terminal to receive data, such as a keypad 30, a touch display (not shown), a joystick (not shown), and/or other input device. In embodiments including a keypad, the keypad may comprise numeric (0-9) and related keys (#, *), and/or other keys for operating the mobile terminal.

As shown in FIG. 2, the mobile terminal 10 may also include one or more means for sharing and/or obtaining data. For example, the mobile terminal may comprise a short-range radio frequency (RF) transceiver and/or interrogator 64 so data may be shared with and/or obtained from electronic devices in accordance with RF techniques. The mobile terminal may comprise other short-range transceivers, such as, for example, an infrared (IR) transceiver 66, a Bluetooth™ (BT) transceiver 68 operating using Bluetooth™ brand wireless technology developed by the Bluetooth™ Special Interest Group, a wireless universal serial bus (USB) transceiver 70 and/or the like. The Bluetooth™ transceiver 68 may be capable of operating according to ultra-low power Bluetooth™ technology (e.g., Wibree™) radio standards. In this regard, the mobile terminal 10 and, in particular, the short-range transceiver may be capable of transmitting data to and/or receiving data from electronic devices within a proximity of the mobile terminal, such as within 10 meters, for example. Although not shown, the mobile terminal may be capable of transmitting and/or receiving data from electronic devices according to various wireless networking techniques, including Wireless Fidelity (Wi-Fi), WLAN techniques such as IEEE 802.11 techniques, and/or the like.

The mobile terminal 10 may comprise memory, such as a subscriber identity module (SIM) 38, a removable user identity module (R-UIM), and/or the like, which may store information elements related to a mobile subscriber. In addition to the SIM, the mobile terminal may comprise other removable and/or fixed memory. The mobile terminal 10 may include volatile memory 40 and/or non-volatile memory 42. For example, volatile memory 40 may include Random Access Memory (RAM) including dynamic and/or static RAM, on-chip or off-chip cache memory, and/or the like. Non-volatile memory 42, which may be embedded and/or removable, may include, for example, read-only memory, flash memory, magnetic storage devices (e.g., hard disks, floppy disk drives, magnetic tape, etc.), optical disc drives and/or media, non-volatile random access memory (NVRAM), and/or the like. Like volatile memory 40 non-volatile memory 42 may include a cache area for temporary storage of data. The memories may store one or more software programs, instructions, pieces of information, data, and/or the like which may be used by the mobile terminal for performing functions of the mobile terminal. For example, the memories may comprise an identifier, such as an international mobile equipment identification (IMEI) code, capable of uniquely identifying the mobile terminal 10.

Referring again to FIG. 1, in an example embodiment, the client device 102 comprises various means, such as a processor 110, a memory 112, a communication interface 114, a user interface 116, and a media playback unit 118, for performing the various functions herein described. The various means of the client device 102 as described herein comprise, for example, hardware elements, e.g., a suitably programmed processor, combinational logic circuit, and/or the like, a computer program product comprising computer-readable program instructions, e.g., software and/or firmware, stored on a computer-readable medium, e.g. memory 112. The program instructions are executable by a processing device, e.g., the processor 110.

The processor 110 may, for example, be embodied as various means including one or more microprocessors with accompanying digital signal processor(s), one or more processor(s) without an accompanying digital signal processor, one or more coprocessors, one or more controllers, processing circuitry, one or more computers, various other processing elements including integrated circuits such as, for example, an application specific integrated circuit (ASIC) or a field programmable gate array (FPGA), or some combination thereof. Accordingly, although illustrated in FIG. 1 as a single processor, in some embodiments the processor 110 comprises a plurality of processors. The plurality of processors may be in operative communication with each other and may be collectively configured to perform one or more functionalities of the media client device 102 as described herein. In embodiments wherein the client device 102 is embodied as a mobile terminal 10, the processor 110 may be embodied as or otherwise comprise the controller 20. In an example embodiment, the processor 110 is configured to execute instructions stored in the memory 112 or otherwise accessible to the processor 110. The instructions, when executed by the processor 110, cause the client device 102 to perform one or more of the functionalities of the client device 102 as described herein. As such, whether configured by hardware or software operations, or by a combination thereof, the processor 110 may represent an entity capable of performing operations according to embodiments of the present invention when configured accordingly. For example, when the processor 110 is embodied as an ASIC, FPGA or the like, the processor 110 may comprise specifically configured hardware for conducting one or more operations described herein. Alternatively, as another example, when the processor 110 is embodied as an executor of instructions, the instructions may specifically configure the processor 110, which may otherwise be a general purpose processing element if not for the specific configuration provided by the instructions, to perform one or more operations described herein

The memory 112 may include, for example, volatile and/or non-volatile memory. Although illustrated in FIG. 1 as a single memory, the memory 112 may comprise a plurality of memories. The memory 112 may comprise volatile memory, non-volatile memory, or some combination thereof. In this regard, the memory 112 may comprise, for example, a hard disk, random access memory, cache memory, flash memory, a compact disc read only memory (CD-ROM), digital versatile disc read only memory (DVD-ROM), an optical disc, circuitry configured to store information, or some combination thereof. The memory 112 may be configured to store information, data, applications, instructions, or the like for enabling the client device 102 to carry out various functions in accordance with embodiments of the present invention. For example, in at least some embodiments, the memory 112 is configured to buffer input data for processing by the processor 110. Additionally or alternatively, in at least some embodiments, the memory 112 is configured to store program instructions for execution by the processor 110. The memory 112 may store information in the form of static and/or dynamic information. This stored information may be stored and/or used by the media playback unit 118 during the course of performing its functionalities.

The communication interface 114 may be embodied as any device or means embodied in hardware, a computer program product comprising computer readable program instructions stored on a computer readable medium (e.g., the memory 112) and executed by a processing device (e.g., the processor 110), or a combination thereof that is configured to receive and/or transmit data from/to a remote device over the network 108. In at least one embodiment, the communication interface 114 is at least partially embodied as or otherwise controlled by the processor 110. In this regard, the communication interface 114 may be in communication with the processor 110, such as via a bus. The communication interface 114 may include, for example, an antenna, a transmitter, a receiver, a transceiver and/or supporting hardware or software for enabling communications with other entities of the system 100. The communication interface 114 may be configured to receive and/or transmit data using any protocol that may be used for communications between computing devices of the system 100. The communication interface 114 may additionally be in communication with the memory 112, user interface 116, and/or media playback unit 118, such as via a bus.

The user interface 116 may be in communication with the processor 110 to receive an indication of a user input and/or to provide an audible, visual, mechanical, or other output to a user. As such, the user interface 116 may include, for example, a keyboard, a mouse, a joystick, a display, a touch screen display, a microphone, a speaker, and/or other input/output mechanisms. The user interface 116 may provide an interface allowing a user to select a media file and/or media tracks thereof to be streamed from the media content source 104 to the client device 102 for playback on the client device 102. In this regard, video from a media file may be displayed on a display of the user interface 116 and audio from a media file may be audibilized over a speaker of the user interface 116. The user interface 116 may be in communication with the memory 112, communication interface 114, and/or media playback unit 118, such as via a bus.

The media playback unit 118 may be embodied as various means, such as hardware, a computer program product comprising computer readable program instructions stored on a computer readable medium (e.g., the memory 112) and executed by a processing device (e.g., the processor 110), or some combination thereof and, in one embodiment, is embodied as or otherwise controlled by the processor 110. In embodiments where the media playback unit 118 is embodied separately from the processor 110, the media playback unit 118 may be in communication with the processor 110. The media playback unit 118 may further be in communication with the memory 112, communication interface 114, and/or user interface 116, such as via a bus.

The media content source 104 may comprise one or more computing devices configured to provide media files to a client device 102. In at least one embodiment, the media content source 104 comprises one or more servers. In an exemplary embodiment, the media content source 104 includes various means, such as a processor 120, memory 122, communication interface 124, user interface 126, and media streaming unit 128 for performing the various functions herein described. These means of the media content source 104 as described herein may be embodied as, for example, hardware elements (e.g., a suitably programmed processor, combinational logic circuit, and/or the like), a computer program product comprising computer-readable program instructions (e.g., software or firmware) stored on a computer-readable medium (e.g. memory 122) that is executable by a suitably configured processing device (e.g., the processor 120), or some combination thereof.

The processor 120 may, for example, be embodied as various means including one or more microprocessors with accompanying digital signal processor(s), one or more processor(s) without an accompanying digital signal processor, one or more coprocessors, one or more controllers, processing circuitry, one or more computers, various other processing elements including integrated circuits such as, for example, an ASIC (application specific integrated circuit) or FPGA (field programmable gate array), or some combination thereof. Accordingly, although illustrated in FIG. 1 as a single processor, in some embodiments the processor 120 comprises a plurality of processors. The plurality of processors may be embodied on a single computing device or distributed across a plurality of computing devices. The plurality of processors may be in operative communication with each other and may be collectively configured to perform one or more functionalities of the media content source 104 as described herein. In an exemplary embodiment, the processor 120 is configured to execute instructions stored in the memory 122 or otherwise accessible to the processor 120. These instructions, when executed by the processor 120, may cause the network entity 104 to perform one or more of the functionalities of media content source 104 as described herein. As such, whether configured by hardware or software methods, or by a combination thereof, the processor 120 may represent an entity capable of performing operations according to embodiments of the present invention when configured accordingly. Thus, for example, when the processor 120 is embodied as an ASIC, FPGA or the like, the processor 120 may comprise specifically configured hardware for conducting one or more operations described herein. Alternatively, as another example, when the processor 120 is embodied as an executor of instructions, the instructions may specifically configure the processor 120, which may otherwise be a general purpose processing element if not for the specific configuration provided by the instructions, to perform one or more algorithms and operations described herein

The memory 122 may include, for example, volatile and/or non-volatile memory. Although illustrated in FIG. 1 as a single memory, the memory 122 may comprise a plurality of memories, which may be embodied on a single computing device or distributed across a plurality of computing devices. The memory 122 may comprise volatile memory, non-volatile memory, or some combination thereof. In this regard, the memory 122 may comprise, for example, a hard disk, random access memory, cache memory, flash memory, a compact disc read only memory (CD-ROM), digital versatile disc read only memory (DVD-ROM), an optical disc, circuitry configured to store information, or some combination thereof. The memory 122 may be configured to store information, data, applications, instructions, or the like for enabling the media content source 104 to carry out various functions in accordance with embodiments of the present invention. For example, in at least some embodiments, the memory 122 is configured to buffer input data for processing by the processor 120. Additionally or alternatively, in at least some embodiments, the memory 122 is configured to store program instructions for execution by the processor 120. The memory 122 may store information in the form of static and/or dynamic information. This stored information may be stored and/or used by the media streaming unit 128 during the course of performing its functionalities.

The communication interface 124 may be embodied as any device or means embodied in hardware, a computer program product comprising computer readable program instructions stored on a computer readable medium, e.g., the memory 122, and executed by a processing device, e.g., the processor 120, or a combination thereof that is configured to receive and/or transmit data from/to a remote device over the network 108. In at least one embodiment, the communication interface 124 is at least partially embodied as or otherwise controlled by the processor 120. In this regard, the communication interface 124 may be in communication with the processor 120, such as via a bus. The communication interface 124 may include, for example, an antenna, a transmitter, a receiver, a transceiver and/or supporting hardware or software for enabling communications with other entities of the system 100. The communication interface 124 may be configured to receive and/or transmit data using any protocol that may be used for communications between computing devices of the system 100. The communication interface 124 may additionally be in communication with the memory 122, user interface 126, and/or media streaming unit 128, such as via a bus.

The user interface 126 may be in communication with the processor 120 to receive an indication of a user input and/or to provide an audible, visual, mechanical, or other output to the user. As such, the user interface 126 may include, for example, a keyboard, a mouse, a joystick, a display, a touch screen display, a microphone, a speaker, and/or other input/output mechanisms. In embodiments wherein the media content source 104 is embodied as one or more servers, the user interface 126 may be limited, or even eliminated. The user interface 126 may be in communication with the memory 122, communication interface 124, and/or media streaming unit 128, such as via a bus.

The media streaming unit 128 may be embodied as various means, such as hardware, a computer program product comprising computer readable program instructions stored on a computer readable medium, e.g., the memory 122, and executed by a processing device, e.g., the processor 120, or some combination thereof and, in one embodiment, is embodied as or otherwise controlled by the processor 120. In embodiments wherein the media streaming unit 128 is embodied separately from the processor 120, the media streaming unit 128 may be in communication with the processor 120. The media streaming unit 128 may further be in communication with the memory 122, communication interface 124, and/or user interface 126, such as via a bus.

In an example embodiment, the media playback unit 118 is configured to send a transfer protocol request for a media file to the media content source 104. In an example embodiment, the requested media file comprises a media file including metadata associated with the media data in the media file. In another example embodiment, the requested media file comprises a media file compliant with the ISO base media file format. Examples of an ISO base media file format comprise a 3GP media file and a moving picture experts group 4 (MPEG-4) Part 14 (MP4) file. The request, for example, is sent in response to a user input or request received via the user interface 116.

The transfer protocol request comprises an indication that the media file is to be streamed to the client device 102. In an example embodiment, the transfer protocol request comprises an HTTP GET request. The HTTP GET request comprises a header field including a token indicating that the media file is to be streamed. For example, the header field may comprise the “Expect” header field and include a token, e.g. “http-streaming”, defined to indicate that the media content source 104 is required to support HTTP streaming of media files, such as 3GPP based HTTP streaming of a 3GP media file. In another example, the header field comprises the “Pragma” header field and includes a token, e.g. “http-streaming”, defined to indicate that the media content source 104 is being queried for support of HTTP streaming of the requested media file.

In an example embodiment, the media streaming unit 128 is configured to receive a transfer protocol request sent by the client device 102. If the transfer protocol request includes an indication that the requested media file is to be streamed to the client device 102 and the media content source 104 is not configured to stream a media file, the media streaming unit 128 is configured to send an error message to the client device 102. If the media content source 104 is configured to stream a media file then the media streaming unit 128 is configured to include support in a reply message sent to the client device 102. Such support may, for example, be indicated as part of the Pragma header field of a HTTP reply message.

In an example embodiment, the media streaming unit 128 is further configured to, in response to receipt of a transfer protocol request for a media file, access the requested media file from the memory 122 or other memory accessible to the media content source 104. The media streaming unit 128 is configured to extract at least a portion of information associated with media data in the media file. In an example embodiment, the extracted portion of information(s) comprises a portion(s) of the metadata associated with media data in the media file. For example, the extracted portion of metadata comprises general information about the content of the media file, e.g., the type(s) of media data and/or the different tracks in the media file. The extracted portion(s) of metadata comprises, for example, only information useful to the client device to select at least one track from the media file.

The metadata associated with the media file, for example, is structured in accordance with the ISO base media file format as outlined in the table below:

| L0 | L1 | L2 | L3 | L4 | L5 | Description |
|---|---|---|---|---|---|---|
| Ftyp | | | | | | File type and compatibility |
| moov | | | | | | Container for all metadata |
| | mvhd | | | | | Movie header, overall declarations |
| | trak | | | | | Container for an individual trak or stream |
| | | tkhd | | | | Track header, overall information in a track |
| | | tref | | | | Track reference container |
| | | mdia | | | | Container for media information in a track |
| | | | mdhd | | | Media header, overall information about the |
| | | | | | | media |
| | | | hdlr | | | Handler, declares the media type |
| | | | minf | | | Media information container |
| | | | | vmhd | | Video media header, overall information for |
| | | | | | | video track only |
| | | | | smhd | | Sound media header, overall information for |
| | | | | | | sound track only |
| | | | | stbl | | Sample table box, container for the time/space |
| | | | | | | map |
| | | | | | stsd | Sample descriptions for the initialization of the |
| | | | | | | media decoder |
| | | | | | stts | Decoding time-to-sample |
| | | | | | ctts | Composition time-to-sample |
| | | | | | stsc | Sample-to-chunk |
| | | | | | stsz | Sample sizes |
| | | | | | stco | Chunk offset to beginning of the file |
| | | | | | stss | sync sample table for Random Access Points |
| moof | | | | | | Movie fragment |
| | mfhd | | | | | Movie fragment header |
| | traf | | | | | Track fragment |
| | | tfhd | | | | Track fragment header |
| | | trun | | | | Track fragment run |
| mfra | | | | | | Movie fragment random access |
| | tfra | | | | | Track fragment random access |
| | mfro | | | | | Movie fragment random access offset |
| mdat | | | | | | Media data container |

In this regard, the media data comprises a hierarchy of a plurality of levels of metadata. Each level comprises one or more sublevels including more specific metadata related to the parent level. For example, a first level, “L0” comprises the metadata categories ftyp, moov, moof, mfra, and mdat. Ftyp and mdat may not include any sublevels. The second level, “L1” of moov may comprise, for example, mvhd and trak. The third level, “L2” of trak, for example, comprises tkhd, tref, and mdia. The fourth level, “L3” of mdia may, for example, comprise mdhd, hdlr, and minf. The fifth level, “L4” of minf may comprise vmhd, smhd, and stbl. The sixth level, “L5,” of stbl may, for example, comprise stsd, stts, ctts, stsc, stsz, stco, and stss. Accordingly, the above table represents a nested hierarchy of blocks of metadata, wherein sublevels of a block of metadata are illustrated in rows below the row including the corresponding parent metadata block and in columns to the right of the column including the corresponding parent block of metadata. Thus, all sublevels of blocks of metadata of the moov block are shown in the rows of the table below the row including the moov block until reaching the row including the “moof” block, e.g., another parent block of metadata, which is on the same level as the moov block. Similarly, all sublevels of blocks of metadata of the stbl block are shown in the rows of the table below the row including the stbl block, until reaching the row including the moof block, which is the first block at a level the same as or higher than the stbl block.

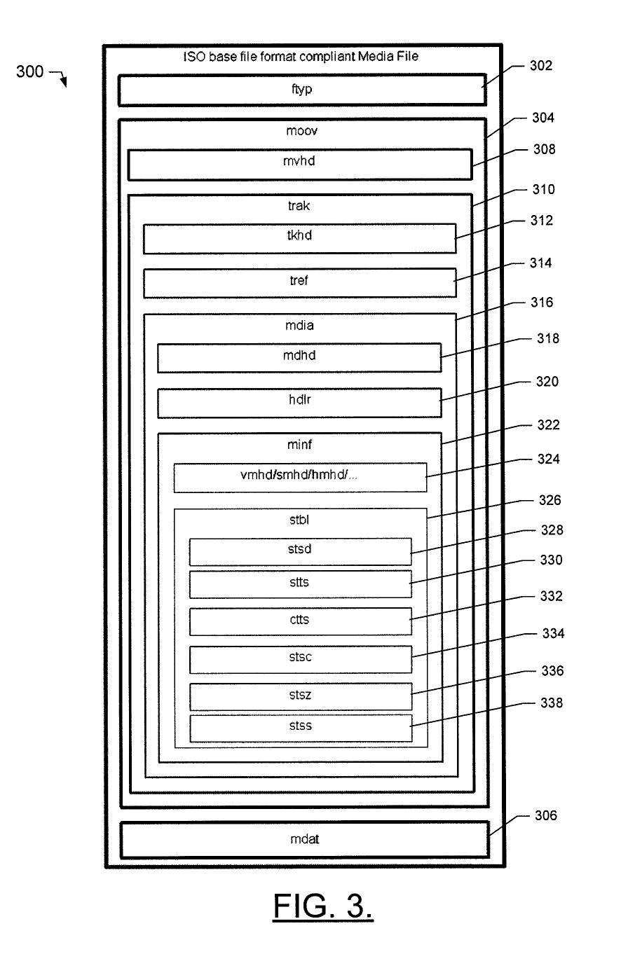

An illustration of an example hierarchy of a plurality of levels of metadata for an ISO base file format compliant media file 300 is illustrated in FIG. 3. In this regard, the metadata 300 comprises a subset of the blocks listed in the above table and is organized in a box-within-a-box structure to illustrate the hierarchy of levels of metadata. In this regard, the ftyp 302, moov 304, and mdat 306 reside on a first level, L0. Moov 304 includes child blocks mvhd 308 and trak 310, at a second level, L1. Trak 310 includes child blocks of metadata tkhd 312, tref 314, and mdia 316, at a third level, L2. Mdia 316 includes child blocks of metadata mdhd 318, hdlr 320, and minf 322, at a fourth level, L3. Minf 322 includes child blocks vmhd/smhd/hmhd 324 and stbl 326, at a fifth level, L4. Stbl 326 includes child blocks of metadata stsd 328, stts 330, ctts 332, stsc 334, stsz 336, and stss 338 at a sixth level, L5.

Accordingly, the media streaming unit 128 may be configured to extract a description of at least a portion of the media file from metadata associated with the media file by extracting one or more blocks of metadata from the metadata associated with the requested media file and/or may extract one or more portion of data included in a block(s) of metadata. The media streaming unit 128 may then progressively transmit the extracted description of at least a portion of the media file to the client device 102. For example, the media streaming unit 128 may first transmit a description of media tracks of the media file to the client device 102. The media streaming unit 128 may, for example, extract the description of media tracks from the tkhd metadata box, which includes track header information and information on one or more tracks of the media file. The media streaming unit 128 may then format a message to the client device 102 including the extracted description of media tracks of the media file and transmit the message to the client device 102. The media streaming unit 128 may then extract a description of one or more portions of media data of the media file (e.g., audio and/or video data comprising the media file) and transmit the extracted description along with the one or more portions of media data of the media file to the client device 102 such that at least a portion of the media data of the media file is streamed to the client device 102. The description of the transmitted media data may, for example, describe a structure of the media data, decoding parameters of the media data, presentation parameters of the media data, and/or other information enabling the client device 102 to playback the streamed media data.

In this regard, the media streaming unit 128 may be configured to selectively extract portions of metadata of a media file and progressively transmit the extracted portions when needed by the client device 102 such that bandwidth required for streaming of a media file using a transfer protocol, such as HTTP is reduced. Thus, a media file's metadata that may otherwise be unsuitable for streaming if transmitted in its entirety may be selectively broken up into extracted portions and only those portions needed by the client device 102 are transmitted. Further, streaming setup time and processing by the client device 102 may be reduced as the client device 102 may receive less data that it needs to process as the client device 102 may receive only that portion of the metadata of the media file, which has been selectively extracted and transmitted by the media content source 104.

The media playback unit 118 may be configured to progressively receive a description of at least a portion of a media file as it is transmitted by the media content source 104. The media playback unit 118 may be configured to use the progressively received description to configure or otherwise set up playback of a steaming media session for a media file streamed by the media content source 104.

In some embodiments, the media playback unit 118 is configured to select a subset of media tracks of the media file based at least in part upon a received description of media tracks of the media file, such as may have been extracted from a tkhd metadata box. The media playback unit 118 may be configured to perform the selection in response to user input received over the user interface 116. The media playback unit 118 may then send an indication of the selection to the media content source 104. The media streaming unit 128 may accordingly receive an indication of a selection of a subset of media tracks of the media file and then may transmit media data of the media file comprising one or more of the selected subset of media tracks to the client device 102.

In at least some embodiments, the media streaming unit 128 is configured to transmit media data from the media file as a series of one or more samples. The series of samples may be transmitted to the client device 102 along with extracted metadata related to each respective sample, such as may describe a structure of the sample, decoding parameters of the sample, presentation parameters of the sample, and/or other information enabling the client device 102 to playback a received sample.

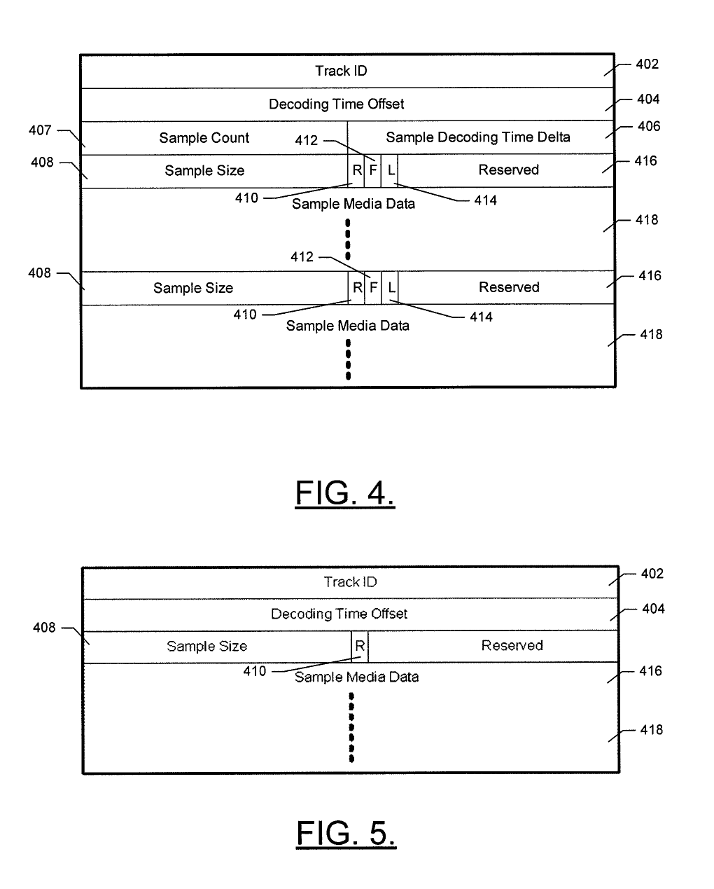

In this regard, FIG. 4 illustrates a framing of a sample divided into a series of fragments according to an exemplary embodiment of the invention. The frame of FIG. 4 may comprise a track ID field 402 indicating an identification of a track of the media file to which the samples included in the frame belong. The media streaming unit 128 may extract the information included in the track ID field 402 from the tkhd, track header/track information, block of the metadata associated with the media file. The frame of FIG. 4 may further comprise a decoding time offset field 404 including information to enable the client device 102 to decode the sample included in the frame. The media streaming unit 128 may extract the information included in the decoding time offset field 404 from the stts (Decoding time-to-sample) block of the metadata associated with the media file. The frame of FIG. 4 may further comprise a sample decoding time delta field 407 including information to enable the client device 102 to decode the sample included in the frame. The media streaming unit 128 may extract the information included in the decoding time delta field 406 from the stts (Decoding time-to-sample) block of the metadata associated with the media file. In this regard, it will be appreciated that since both information included in the decoding time offset field 404 and sample decoding time delta field 406 may be extracted from the same block of meta data, that the media streaming unit 128 may be configured to extract only a portion of data included in a block of metadata to populate a field of a message sent to the client device 102. The frame of FIG. 4 may further comprise a sample count field 407 that indicates how many sample fragments, e.g., sample media data 418s, are included in the frame.

For a sample fragment of media data included in the frame of FIG. 4, a field may indicate the sample size 408. Further, one or more flag indicators may be included in the frame of FIG. 4 to indicate a position of a sample fragment, such as a relative positioning of the sample fragment within a track of the media file and/or within the sample. The R flag 410 may indicate whether the sample fragment comprises a random access point. The F flag 412 may indicate whether the sample fragment is the first fragment of a sample. The L flag 414 may indicate whether the sample fragment is the last fragment of a sample.

FIG. 5 illustrates a framing of a sample according to another exemplary embodiment of the invention. In this regard, a sample that may be framed in the framing of FIG. 5 is not divided into fragments as in the framing of FIG. 4 and accordingly, the sample count field 407, F flag 412, and L flag 414 may not be needed. The remaining fields included in the framing of FIG. 5 may be substantially similar to those described in connection with FIG. 4.

The media playback unit 118 may be configured to control the streaming of a media file by sending transfer protocol command messages to the media content source 104. The media streaming unit 128 may be configured to change a parameter of the streaming session, such as by starting streaming, e.g., in response to a “play” command, pausing the streaming, e.g., in response to a “pause” command, or ending the session, e.g., in response to a “stop” command. A transfer protocol command message sent by the media playback unit 118 may be formatted in accordance with HTTP, such as an HTTP GET message, and a streaming control command may be included in the command message as a token in a header field of the HTTP command message. Such a token may, for example, be included in the Pragma header field of the HTTP command message. For example, the token may, for example, have one of the following values:
PLAY: indicates that the media content source 104 should begin to transmit media data of the media file so that playback of streaming content on the client device 102 may begin.
PAUSE: indicates that media data transmission should be paused. Keep alive messages may be exchanged between the client device 102 and media content source 104 to keep the persistent TCP connection alive.
TEARDOWN: indicates that the media content source 104 should cease to transmit media data such that streaming session will be stopped.

A transfer protocol command message for controlling streaming of a media file may additionally include tokens indicating one or more additional or alternative commands related to streaming of a media file. For example, a “range” token may indicate a desired start and end position for the media playback. The range may be indicated in Network Play Time (NPT), which is relative to the start of the media file. Information extracted from, for example, the stss, stts, and mvhd blocks of metadata of the media file may be used to locate the appropriate starting point and duration of a media clip. A “tracks” token may identify one or more tracks from which media data is to be transmitted (e.g., streamed) to the client device 102. An “inband” token may indicate whether media data is carried in the same TCP session or over another TCP session. A “seq” token may indicate a sequence number of a request. A “SyncTolerance” token may indicate a tolerance of the client device 102 with respect to out-of-sync delivery of media data by the media content source 104.

In some embodiments, the media streaming unit 128 may be configured to transmit and the media playback unit 118 may be configured to receive data from multiple media tracks of a media file over a single TCP session. In such embodiments, samples from the different media tracks may be interleaved. The media streaming unit 128 may be configured to control the interleaving process such that the samples are synchronized up to a synchronization tolerance limit specified by the client device 102 and/or by the media content source 104.

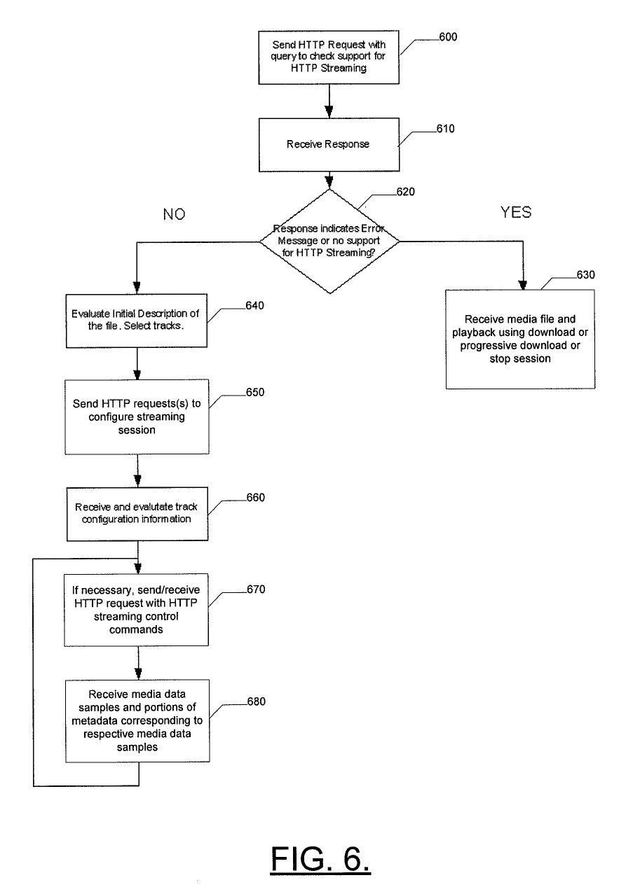

FIG. 6 is a flowchart illustrating a method for streaming media files using a transfer protocol, such as HTTP, according to an example embodiment of the invention. As noted above, the use of HTTP as a transport protocol in conjunction with FIG. 6 is provided by way of example and not of limitation, as other transfer protocols may be similarly employed. Regardless of the transfer protocol used, FIG. 6 illustrates operations that occur at a client device 102. At 600, an HTTP request for a media file, with a query to determine support of the media content source 104 of HTTP streaming, is sent for example by the media playback unit 118. At 610, a response to the HTTP request is received by the media playback unit 118 from the media content source 104. At 620, the media playback unit 118 determines whether the response comprises an error message or indicates that the media content source 104 does not support HTTP streaming. If the media playback unit 118 determines at 620 that the response does comprise an error message or indicates that the media content source 104 does not support HTTP streaming, the media playback unit 118 may receive the requested media file using download or progressive download protocols, or may stop the session, at 630.

If, on the other hand, the media playback unit 118 determines at 620 that the response does not comprise an error message and/or indicates that the media content source 104 does support HTTP streaming, the media playback unit 118 evaluates at least one received metadata portion associated with the media data in the media file. For example, if the media content source 104 supports HTTP streaming, at least one portion of the metadata, associated with the media data in the media file, is included in the response by the media content source. The included portions of metadata, for example, comprise information about types of media data in different tracks in the media file. At 640, the received metadata is evaluated and a subset of tracks of the media file, is selected by the media playback unit 118. At 650, one or more HTTP requests are sent by the media playback unit 118 to the media content source 104 to configure the streaming session. The configuration settings, for example, include configuration settings providing for audio/video data to be delivered over the same or over different TCP connections. At 660, track configuration information, for one or more of the selected subset of media tracks, is received and evaluated by the media playback unit 118. At 670, the media playback unit 118 may further send, in an example, HTTP command request messages with HTTP streaming control commands to the media content source 104 to control streaming of the media file. In an alternative example, the media content source 104 may start transmitting media data associated with the selected track without receiving HTTP streaming control commands. At 680, the media playback unit 118 receives chunks of media data with their corresponding metadata portions progressively from the media content source 104. For example, a received data block comprises at least one chunk of media data and portions of metadata useful for decoding and/or playing back the at least one chunk of media data. In an example embodiment, a chunk of media data comprises a sample media data, e.g., a frame. In another example embodiment, a chunk of media data comprises a portion of a sample media data, e.g., portion of a frame. The media playback unit 118 further demultiplexes the received media data and forwards it to buffers or media decoders of the client device 102 for playback.

According to example embodiments of the present invention, portions of metadata are progressively transmitted, to the client device 102, with corresponding chunks of media data. Metadata, in a media file, usually comprises information associated with different samples within a track. The increase in the number of tracks in a media file and/or the increase in the number of samples within at least one track usually leads to an increase in the size of the metadata in the media file. Transmitting all, or most of, the metadata in the media file at the start of a media delivery session, e.g., like the case of download and/or progressive download, may lead to relatively large delay in the start of playback of media data. According to an example embodiment of the present invention, real-time HTTP streaming is achieved by progressively transmitting portions of metadata with corresponding chunks of media data. For example, only portions of the metadata that are useful for the client device in decoding and/or playing back the chunks of media data are transmitted.

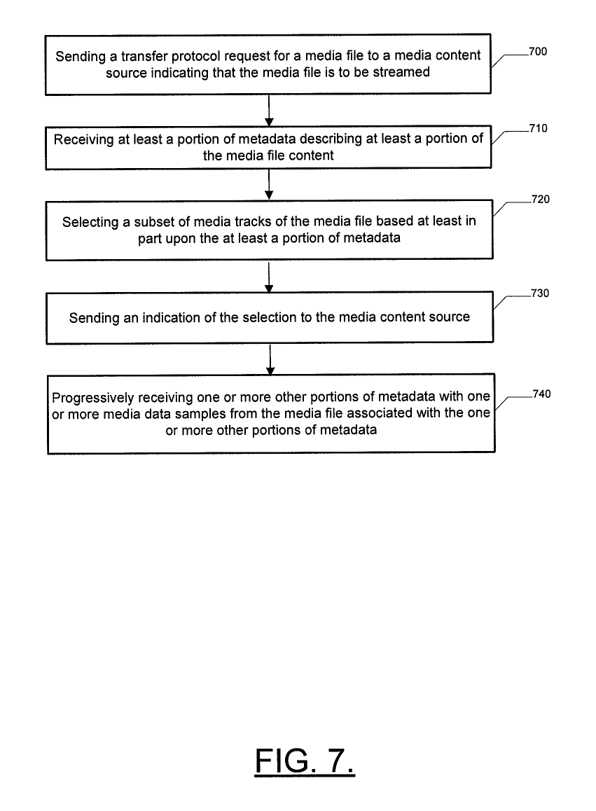

FIG. 7 illustrates a flowchart according to an exemplary method for streaming media files using a transfer protocol, such as HTTP, according to an exemplary embodiment of the invention. As noted above in conjunction with FIG. 6, the use of HTTP as a transfer protocol in conjunction with FIG. 7 is provided by way of example and not of limitation, as other transport protocols may be similarly employed. Regardless of the transfer protocol used, FIG. 7 illustrates operations that occur at a client device 102. The method may include the media playback unit 118 sending a transfer protocol request for a media file to a media content source 104 indicating that the media file is to be streamed, at operation 700. Operation 710 may comprise the media playback unit 118 receiving at least a portion of metadata describing at least a portion of the media file content. The media playback unit 118 may then optionally select, such as in response to user input, a subset of media tracks of the media file based at least in part upon the received at least a portion of metadata, at operation 720. Operation 730 may then comprise the media playback unit 118 sending an indication of the selection (if made) to the media content source 104. The media playback unit 118 may then progressively receive one or more other portions of metadata with one or more media data samples from the media file associated with the one or more other portions of metadata. If a selection of a subset of media tracks was made, the received one or more media data samples may be associated with at least one of the selected subset of media tracks.

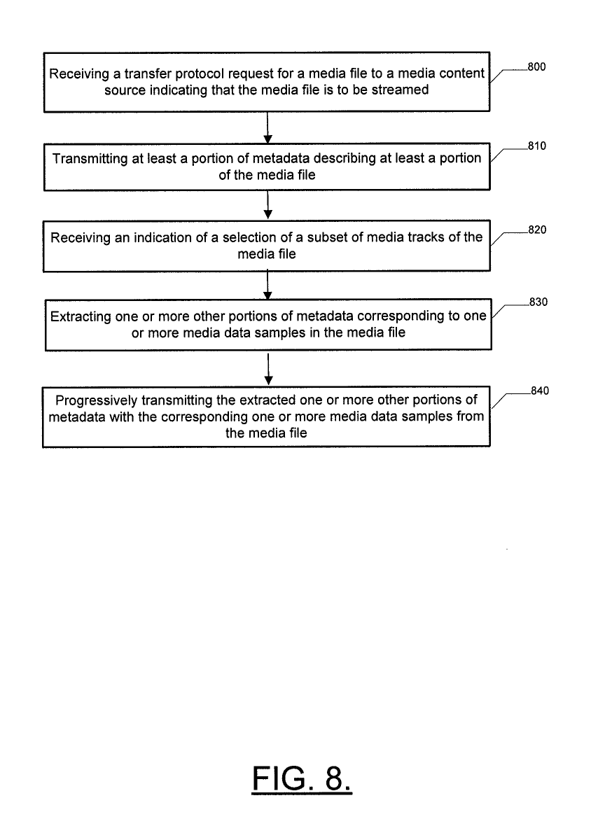

FIG. 8 illustrates a flowchart according to an exemplary method for streaming media files using a transfer protocol, such as HTTP, according to an exemplary embodiment of the invention. It will again be appreciated that the use of HTTP as a transport protocol in conjunction with FIG. 8 is provided by way of example and not of limitation, as other transport protocols may be similarly employed. Regardless of the transport protocol used, FIG. 8 illustrates operations that may occur at a media content source 104. The method may include the media streaming unit 128 receiving a transfer protocol request for a media file indicating that the media file is to be streamed, at operation 800. Operation 810 may comprise the media streaming unit 128 transmitting at least a portion of metadata describing at least a portion of the media file. The media streaming unit 128 may then optionally receive an indication of a selection of a subset of media tracks of the media file, at operation 820. Operation 830 may comprise the media streaming unit 128 extracting one or more other portions of metadata corresponding to one or more media data samples in the media file. If an indication of a selection was received, the one or more media data samples may be associated with at least one of the selected subset of media tracks. The media streaming unit 128 may then progressively transmit the extracted one or more other portions of metadata with the corresponding one or more media data samples from the media file, at operation 840.

FIGS. 6-8 are flowcharts of a system, method, and computer program product according to exemplary embodiments of the invention. It will be understood that each block of the flowcharts, and combinations of blocks in the flowcharts, may be implemented by various means, such as hardware and/or a computer program product comprising one or more computer-readable mediums having computer readable program instructions stored thereon. For example, one or more of the procedures described herein may be embodied by computer program instructions of a computer program product. In this regard, the computer program product(s) which embody the procedures described herein may be stored by one or more memory devices of a mobile terminal, server, or other computing device and executed by a processor in the computing device. In some embodiments, the computer program instructions comprising the computer program product(s) which embody the procedures described above may be stored by memory devices of a plurality of computing devices. As will be appreciated, any such computer program product may be loaded onto a computer or other programmable apparatus to produce a machine, such that the computer program product including the instructions which execute on the computer or other programmable apparatus creates means for implementing the functions specified in the flowchart block(s). Further, the computer program product may comprise one or more computer-readable memories on which the computer program instructions may be stored such that the one or more computer-readable memories can direct a computer or other programmable apparatus to function in a particular manner, such that the computer program product comprises an article of manufacture which implements the function specified in the flowchart block(s). The computer program instructions of one or more computer program products may also be loaded onto a computer or other programmable apparatus to cause a series of operations to be performed on the computer or other programmable apparatus to produce a computer-implemented process such that the instructions which execute on the computer or other programmable apparatus implement the functions specified in the flowchart block(s).

Accordingly, blocks of the flowcharts support combinations of means for performing the specified functions. It will also be understood that one or more blocks of the flowcharts, and combinations of blocks in the flowcharts, may be implemented by special purpose hardware-based computer systems which perform the specified functions, or combinations of special purpose hardware and computer program product(s).

The above described functions may be carried out in many ways. For example, any suitable means for carrying out each of the functions described above may be employed to carry out embodiments of the invention. In one embodiment, a suitably configured processor may provide all or a portion of the elements of the invention. In another embodiment, all or a portion of the elements of the invention may be configured by and operate under control of a computer program product. The computer program product for performing the methods of embodiments of the invention includes a computer-readable storage medium, such as the non-volatile storage medium, and computer-readable program code portions, such as a series of computer instructions, embodied in the computer-readable storage medium.

As such, then, several advantages are provided to computing devices, computing device users, and network operators in accordance with embodiments of the invention. For example, streaming of media content may be provided, such as by using TCP over HTTP, without limit to a proprietary media format. In this regard, streaming of media content may be facilitated for media content formatted in accordance with any media file format based upon the International Organization for Standardization (ISO) base media file format. A protocol for streaming of media content may also be provided, such as by using TCP over HTTP, that is interoperable with various network types, including, for example, local area networks, the Internet, wireless networks, wireline networks, cellular networks, and the like.

Network bandwidth consumption and processing requirements of computing devices receiving and playing back streaming media may also be reduced pursuant to embodiments of the invention. In this regard, network bandwidth may be more efficiently used by reducing the amount of metadata transmitted for a media file by selectively extracting and progressively delivering only that data required by the receiver for playback of the streaming media. A device playing back the streaming media in accordance with embodiments of the invention may also benefit by not having to receive and process as much data.

Many modifications and other embodiments of the inventions set forth herein will come to mind to one skilled in the art to which these inventions pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method comprising:
receiving a transfer protocol request for a media file indicating that the media file is to be streamed to a client device requesting the media file;
transmitting at least a portion of metadata describing at least a portion of the media file content;
extracting one or more other portions of metadata corresponding to one or more media data samples in the media file; and
progressively transmitting the extracted one or more other portions of metadata with the corresponding one or more media data samples from the media file.

2. The method of claim 1, wherein receiving a transfer protocol request comprises receiving a hypertext transfer protocol GET request comprising a header field including a token indicating that the media file is to be streamed.

3. The method of claim 1, wherein said one or more other portions of metadata describe one or more of a structure of the media data, decoding parameters of the media data, or presentation parameters of the media data.

4. The method of claim 1, further comprising:
receiving a selection of a subset of media tracks of the media file; and wherein
the progressively transmitted one or more media data samples being associated with at least one of the selected subset of media tracks.

5. The method of claim 1, wherein receiving a transfer protocol request comprises receiving a transfer protocol request at a media content source; and further comprising accessing the requested media file from a memory.

6. A computer program product comprising at least one computer-readable storage medium having computer-readable program instructions stored therein, the computer-readable program instructions, when executed, cause an apparatus the perform the method of claim 1.

7. An apparatus comprising:
a processor, and
a memory storing executable instructions,
the memory and the executable instructions, with the processor, being configured to cause the apparatus to at least:
receive a transfer protocol request for a media file indicating that the media file is to be streamed to a client device requesting the media file;
transmit at least a portion of metadata describing at least a portion of the media file content;
extract one or more other portions of metadata corresponding to one or more media data samples in the media file; and
progressively transmit the extracted one or more other portions of metadata with the corresponding one or more media data samples from the media file.

8. The apparatus of claim 7, wherein the memory and the executable instructions, with the processor, being configured to cause the apparatus to receive a transfer protocol request by receiving a hypertext transfer protocol GET request comprising a header field including a token indicating that the media file is to be streamed.

9. The apparatus of claim 7, wherein the one or more other portions of metadata describe one or more of a structure of the media data, decoding parameters of the media data, or presentation parameters of the media data.

10. The apparatus of claim 7, wherein the memory and the executable instructions, with the processor, being configured to further cause the apparatus to:
receive a selection of a subset of media tracks of the media file; and wherein
the instructions when executed by the processor cause the apparatus to progressively transmit one or more media data samples by progressively transmitting one or more media data samples associated with at least one of the selected subset of media tracks.

11. A method comprising:
sending a transfer protocol request for a media file to a media content source, wherein the transfer protocol request indicates that the media file is to be streamed;
receiving at least a portion of metadata describing at least a portion of the media file content; and
progressively receiving one or more other portions of metadata with corresponding one or more media data samples from the media file.

12. The method of claim 11, wherein sending a transfer protocol request comprises sending a hypertext transfer protocol GET request comprising a header field including a token indicating that the media file is to be streamed.

13. The method of claim 11, wherein the one or more other portions of metadata describe one or more of a structure of the media data, decoding parameters of the media data, or presentation parameters of the media data.

14. The method of claim 11, further comprising:
selecting a subset of media tracks of the media file based at least in part upon the received at least a portion of metadata; and
sending an indication of the selection to the media content source; and wherein
progressively receiving one or more other portions of metadata with the corresponding one or more media data samples from the media file comprises progressively receiving one or more media data samples associated with at least one of the selected subset of media tracks.

15. A computer program product comprising at least one computer-readable storage medium having computer-readable program instructions stored therein, the computer-readable program instructions, when executed, cause an apparatus to perform the method of claim 11.

16. An apparatus comprising:
a processor, and
a memory storing executable instructions,
the memory and the executable instructions, with the processor, being configured to cause the apparatus to at least:
send a transfer protocol request for a media file to a media content source, wherein the transfer protocol request indicates that the media file is to be streamed;
receive at least a portion of metadata describing at least a portion of the media file content; and
progressively receive one or more other portions of metadata with corresponding one or more media data samples from the media file.

17. The apparatus of claim 16, wherein the memory and the executable instructions, with the processor, being configured to cause the apparatus to send a transfer protocol request by sending a hypertext transfer protocol GET request comprising a header field including a token indicating that the media file is to be streamed.

18. The apparatus of claim 16, wherein the one or more other portions of metadata describe one or more of a structure of the media data, decoding parameters of the media data, or presentation parameters of the media data.

19. The apparatus of claim 16, wherein the memory and the executable instructions, with the processor, being configured to further cause the apparatus to:
select a subset of media tracks of the media file based at least in part upon the received at least a portion of metadata; and
send an indication of the selection to the media content source; and wherein
the memory and the executable instructions, with the processor, being configured to progressively receive one or more other portions of metadata with the corresponding one or more media data samples from the media file by progressively receiving one or more media data samples associated with at least one of the selected subset of media tracks.
